(19) United States
(12) Patent Application Publication
(10) Pub. No.: US 2002/0191035 A1
(43) Pub. Date: Dec. 19, 2002

(54) Computerized customizable scheduler

(76) Inventor: Harry Selent, Punta Gorda, FL (US)

Correspondence Address: FRANK A. LUKASIK, SUITE 142, 1250 WEST MARION AVE., PUNTA GORDA, FL, 33950, US

(21) Appl. No.: 09/884,315

(22) Filed: Jun. 19, 2001

(51) Int. Cl. G06F 3/00

(52) U.S. Cl. 345/866

(57) ABSTRACT

The present invention is a method of using a computer to create, maintain, modify and customize a database based scheduling calendar capable of coordinating availability schedules of physicians, technicians, equipment, facilities and any other component required for the scheduled delivery of a service to a customer, patient or other consumer and for interactively creating and viewing reports as to the status of appointments, schedules, customers, service providers and resources.

### TECHNICAL FIELD OF THE INVENTION

This invention relates in general to computer programs, and in particular to an improved method of customizing, displaying and accessing a scheduling calendar and database for individual or business use.

### BACKGROUND OF THE INVENTION

In conventional scheduling calendar software packages, users are limited to what amounts to a traditional paper calendar converted to a computerized form. Calendars in this form come in versions which allow for viewing of a month, week or day and some allow for attachments to particular time slots to provide notes and details relating to the event noted at that time slot. Some prior art calendars permit comparisons to be made between individual schedules so that meetings can be arranged to accommodate the maximum number of attendees, others allow employees to access a master calendar for holiday scheduling.

In a cooperative electronic environment represented by a distributed computer network where computers can communicate with each other, calendar programs allow users to electronically query each others'schedules. Accordingly, an individual user of a calendar program in a group of users can pick a time at which to plan a meeting which does not conflict with the schedules of proposed attendees. The individual user can direct a computer to query a computer file (or files) maintained by the calendar program. The computer file contains, among other things, availability information including the times of the day that each of the proposed attendees using the calendar program are either free or busy (the “free/busy information”). In this manner, the individual user is presented with the times of day that each of the proposed attendees can or cannot attend the meeting. This feature allows the individual user to pre-select an appropriate day and time to plan the meeting so that the largest number of proposed attendees can attend.

Several problems face existing calendar programs. One problem is the closed-environment nature of the existing calendar programs. A user of an existing calendar program only has access to the availability information of the other users of the existing calendar program. This limitation creates a problem if the user wishes to invite a non-user of the existing calendar program to attend the meeting. The user does not have access to the schedule of the non-user, even if the non-user maintains an electronic calendar, albeit on a different calendar program.

Most existing calendar programs maintain the availability information for each of the users in a single file having a proprietary format such that non-users cannot easily access it. The reason is three fold: (1) it makes locating and accessing the information easier for the calendar program, (2) individuals generally do not want to allow public access to their personal or business calendars, and (3) calendar programs typically have a proprietary data format and access infrastructure. For security reasons, it makes sense not to allow anyone outside of the users of the particular calendar program to have access to the schedules of the users. On the other hand, often is the case that a user will desire to plan a meeting and to invite a non-user or, in a professional environment such as a Doctor or Dentist clinic, a patient wishes to check for an open appointment slot by accessing a screen displaying the health care provider's schedule.

Most health care clinics/offices, rely upon a receptionist to set and regulate patient appointments, again, such systems even when computerized, rely upon an electronic version of the calendar and appointment book. Often, an appointment with a physician requires the concurrent scheduling of other resources such as nurses, operating theaters, x-ray machines and other ancillaries and a basic “appointment book” system is inadequate.

Accordingly, a need exists for a system which allows both users and non-users of a calendar program to have access to the availability information associated with the schedules of each of the users, while not allowing non-users access to the actual calendars of the users. Additionally, a need exists for a dynamic scheduling system capable of coordinating availability schedules of physicians, technicians, equipment, facilities and any other component required for the scheduled delivery of a service to a customer, patient or other consumer and to have comprehensive reporting capabilities that are useful in the planning, management and marketing functions of an individual or business.

### SUMMARY OF THE INVENTION

A preferred embodiment of the program of the present invention, having been refined, modified and designed through experimentation and restricted beta test sites, provides a customizable software method for creating and maintaining a scheduling calendar for people and resources and to permit thereby the coordinated scheduling of discrete components in a professional, personal or service environment and in so doing, maintains and updates a database to augment the scheduling calendar and which has extensive reporting functions that are useful in the planning, management and marketing functions of an individual or business.

In describing the present invention certain nomenclature is appropriate and defined hereunder;

Accounts: Schedule configured for a particular user.

Appointment; Any pre-set time allocation.

Appointment information: Details of an appointment, when, who etc.

Group: Any group of users, providers or resources.

Note Template: A pre-set format by which notes are configured as to content, location and appearance.

Permissions: Assignment of access security levels.

Productivity Report: Report generated which shows for any individual or group, the ratio of productive (scheduled appointments) time against unproductive (unscheduled) time.

Provider. A person who is a service provider, technician, physician or other person delivering any service type or for whom appointments need to be maintained.

Referral Source: A tracking feature enabling the user to determine where and how many referrals came from a given source.

Reminder Message: A message which issues a prompt to the user at a pre-set time.

Resource: Any equipment, facility or other logistical asset.

Service code recall report: A report which permits the tracking and management of patient, customer, client etc, visits for a particular type of service. (i.e. A dentist may track patients who have/have not received a dental cleaning within a given period, so as to target those patients for call in.)

Template: A pre-set format by which screens are configured as to content, location and appearance.

Transaction: An event or occurrence within a scheduled appointment.

User: That individual operating the scheduling program in a particular configuration at any given time.

Visit: A time when a patient, customer, client etc receives service or is scheduled for an appointment.

Waiting list: Names of people awaiting an appointment assignment.

Zip code referral: A method of tracking customer revenue by Zip code.

It is a further object of the invention to provide means for the user to modify/customize the software by activating or deactivating available features and functions through the use of drop down menus and toggle switches selected by the mouse or keyboard.

It is a further object of the invention to provide a means for controlling access to specific customization features and functions of the program through hierarchal security filters which give system administrators complete access and the ability to restrict or permit others'access as required.

It is a further object of the invention to provide means by which notes can be attached to calendar events or any other field within the calendar view and by which such notes are viewed in any desired order through use of scroll bars.

It is a further object of the invention to provide means by which databases can be maintained and a current database can be chosen upon program start.

It is a further object of the invention to provide means by which a prioritized waiting list can be assembled and maintained so that open schedule slots can be assigned to waiting list items and waiting list items can be dragged and dropped into available appointment slots.

It is a further object of the invention to provide means by which the appearance of the program opening screen and available windows therein can be modified.

It is a further object of the invention to provide means by which time slots can be tagged to show those slots available for scheduling and those which are barred from scheduling or require special permission for scheduling

It is a further object of the invention to provide means by which descriptive textual tags appear as the mouse pointer is scrolled across menu items in the various views.

It is a further object of the invention to provide means by which customizing options are given to permit the user to select for appointments; start/end times, time formats, appointment interval, first day of the week, holiday color and font style, use of different color for holiday if desired, font style for windows fonts, color for time display font, color of default appointment cell, background color of appointment grid, color of (time) conflict cell, color of breaks or non-schedulable time slots, minimum cell height, width and;

Yes/no options for; show time scale, use half tone color for backgrounds, auto-resize appointment cells, prompt before applying changes to all cells, enable dragging and dropping of appointments, prompt before dragging and dropping of appointments, warn when scheduling to a non-default (service) provider, warn when number of authorized visits remaining is less than :xx (choice), use of grayscale when printing the appointment grid, use of database wizard on startup, use of wizard in creating a new database, use of alternating colors in reports, always show drop down lists and select # of rows in drop down list, and;

Choices for; for viewing multiple appointments in the same cell-horizontal or vertical format, optional calculator program, refresh interval time, check boxes to choose different appointment types;

Status, Break, Template, Above template, Customer image, Notes, Recurring appointment, Group appointment, Sent E-Mail, Sent Letter.

It is a further object of the invention to provide means by which reports can be generated, viewed, printed or exported which show;

Today's appointments, Appointment grid, Appointment list, Mailing labels, Providers list, Customers list, Service code list, Appointment status report, No show list, Top 25 list, Appointment reminder messages, Sent reminder messages, Productivity report, Referral source report, Zip code referral report, Authorized visit Alert report, Revenue generation report, Service code recall report and a report summary.

It is a further object of the invention to provide means by which customized e-mail reminder or printed messages can be sent to clients, customers, patients and other individuals contained within the databases of the present invention program to remind them of their appointment time or to give other information relevant to appointment.

It is a further object of the invention to provide means by which prospective patients, clients, customers or other individuals seeking to schedule an appointment for service can remotely access the calendar schedule of a service provider to search for and reserve a suitable appointment time. Such remote access being either via the Internet or any other network system to which the prospective patient/client has access.

It is a further object of the invention to provide means by which directions to a customer's location, residence etc can be attached as an information field within the program database.

### BRIEF DESCRIPTION OF THE DRAWINGS

For a more complete understanding of the present invention and the advantages thereof, reference is now made to the Detailed Description taken in conjunction with the attached drawings in which;

FIG. 1 is a weekly calendar view in accordance with the present invention.

FIG. 2 is a daily calendar view in accordance with the present invention.

FIG. 3 is a monthly calendar view in accordance with the present invention.

FIGS. 4 and 4a are enlarged detailed views of the menu options of the present invention.

FIGS. 5-12 are a series of detailed views showing successive option screens by which the look, feel, and function of the present invention program is customized.

FIG. 13 is enlarged detailed views of the edit menu options of the present invention.

FIGS. 14-25 are a series of screen views of the present invention program through which the underlying databases of the present invention can be modified, updated and organized.

FIGS. 26 and 26a are enlarged detailed views of the View and Activity menus of the present invention.

FIG. 27 is an enlarged detailed view of the Reports menu options of the present invention.

FIG. 28 is an enlarged detailed view of the Help menu options of the present invention.

### DETAILED DESCRIPTION OF A PREFERRED EMBODIMENT OF THE INVENTION

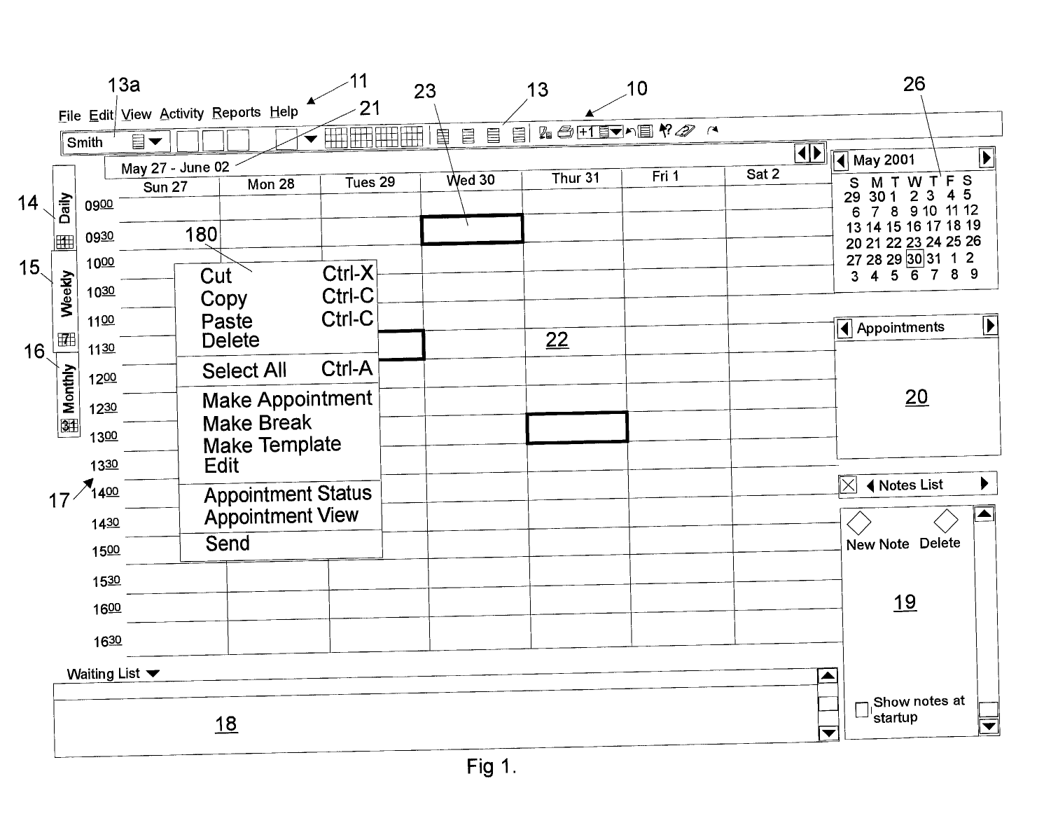

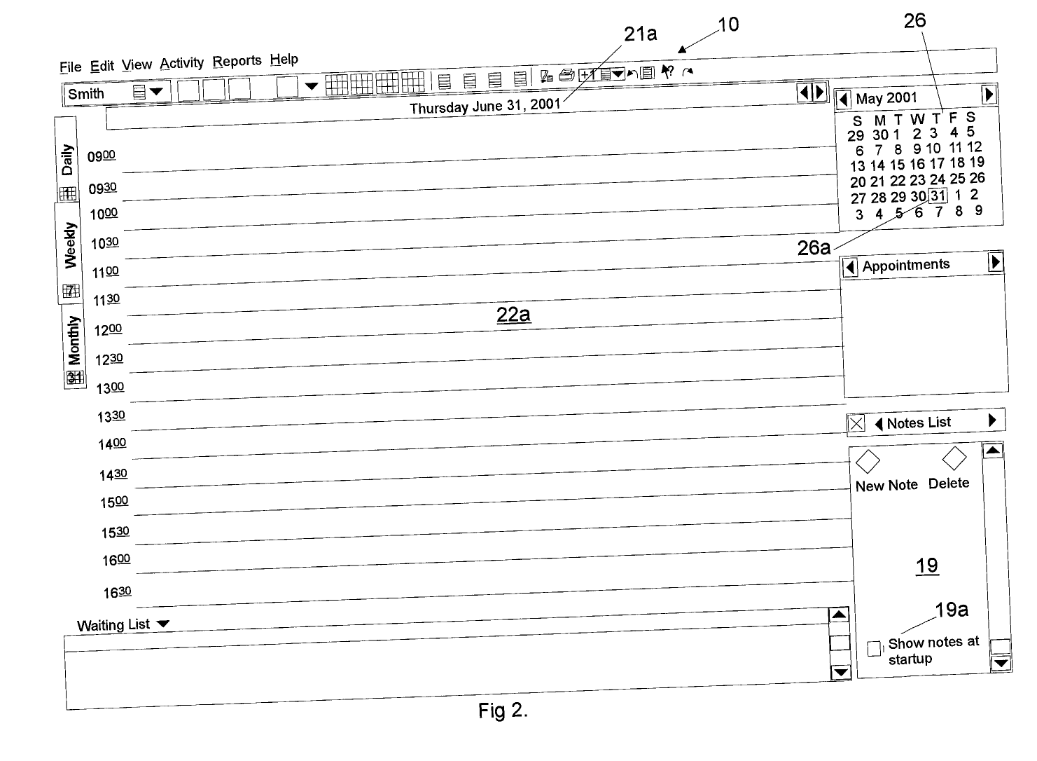

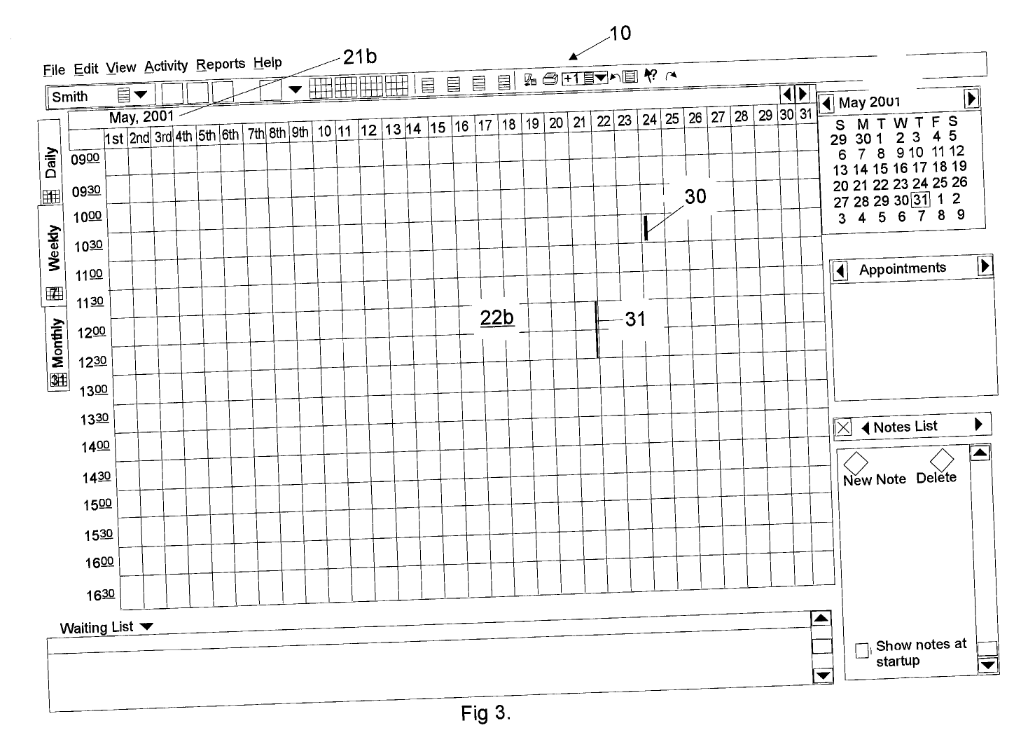

Referring now to the drawings wherein like numerals designate like and corresponding parts throughout the several views, in FIG. 1 the main screen view is designated overall by the numeral 10. Menu bar 11 contains choices familiar to the Microsoft Windows® operating environment. Horizontal tool bar 13 generally overlies the calendar view below. Weekly calendar 22 is comprised of a grid of open squares arranged in a series of seven columns, each column having a heading with a day/date designation. Time scale 17 is vertically arrayed to the left side of calendar grid 22 and is, in this example, subdivided into 30 minute increments ranging from 09:00 at the top to 16:30 at the bottom. As will be shown herein, time scale 17 can be modified according to the user, to reflect whatever time unit is required. View buttons 14-16 are arrayed vertically on the left of the screen view. These buttons permit quick view changes between daily 14, weekly 15, and monthly 16 views, the latter views being illustrated herein in FIGS. 2 and 3. Monthly calendar 26 is positioned to the right of calendar grid 22 and is the uppermost block in a vertical series of three blocks, the other blocks being Appointments screen 20 and Notes screen 19 the functions of which are described in detail herein. Waiting list 18 generally underlies calendar grid 22 and is so positioned to permit the “dragging and dropping” of items on waiting list 18 to open slots on calendar grid 22. Scroll window 13a is positioned at the left extreme of horizontal tool bar 13 and displays the name of the current “provider” whose schedule is currently displayed. Date scale 21 displays the date range for the calendar being viewed. Cell 23 formed at the intersection of vertical and horizontal lines emanating from time and day periods, is a “live” space into which text can be typed, modified or otherwise viewed by “right clicking” the mouse and activating drop down menu 180 to access other operating choices.

Referring now to FIG. 2 which contains the same menu options and choices as FIG. 1 but displays only the schedule for a single day. Calendar 26 highlights the day with box 26a and text block 21a places the day and date at the top of screen 22a.

Referring now to FIG. 3 which contains the same menu options and choices as FIGS. 1 and 2 but displays a grid 22b which represent time slots for an entire month as shown by text block 21b. Bars 30 and 31 are positioned respectively on the left and right of two cell units. Bar 30 in the left side position denotes an appointment at that time. Bar 31 on the right side of a cell(s) denotes a block out period when no scheduling is permitted. Scrolling the mouse pointer over the cell activates text box 181 which displays the reason for the unavailability of that time slot.

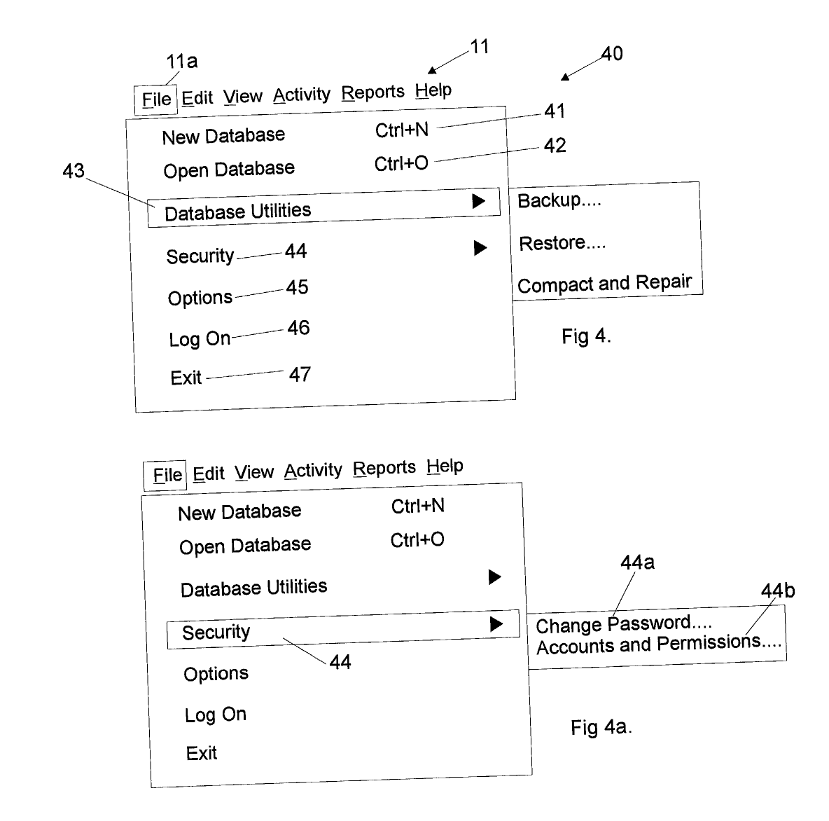

Referring now to FIGS. 4 and 4a which give access to menu features under the File button 11a. Buttons 41, 42 and 43 activate database operations. New Database 41, activates a four step Database creation wizard allowing the user to name the database, specify the qualifications/description of the provider, the event or service, and the time period(s) allocated for such service. The final step of the Wizard is to automatically import data from other databases relating to the new subject. Open database 42 is the usual file selection process to pick an item from a Microsoft Windows® screen. Database utilities button 42 gives access to the functions of Backup, Restore, Compact and repair databases.

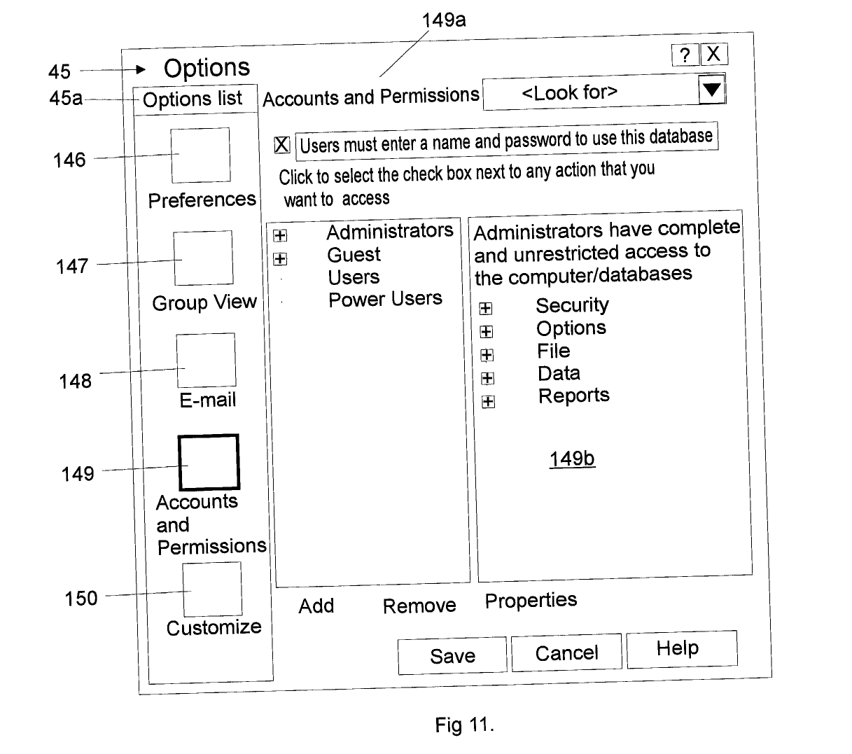

Security button 44 opens to options 44a to change access password and to option 44b Accounts and permissions which opens to a separate Window—see FIG. 11 (later described in detail).

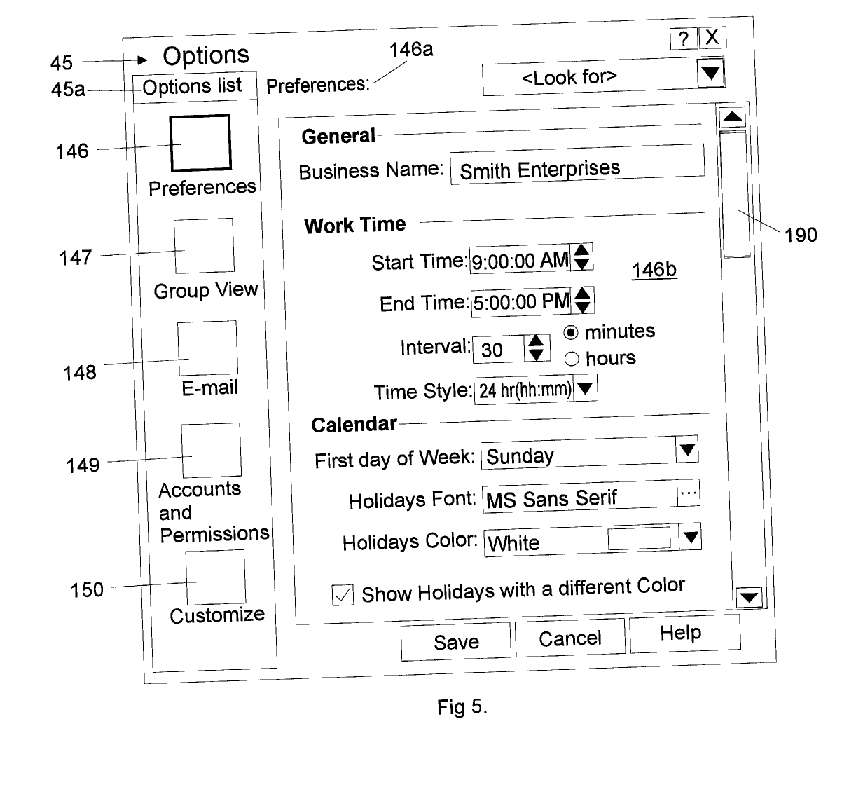

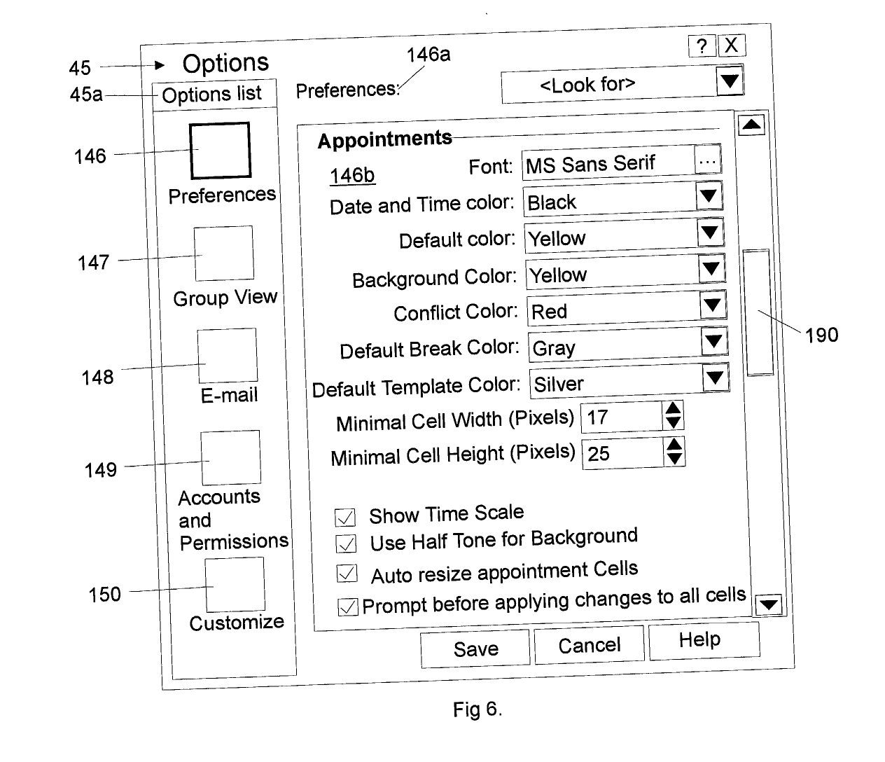

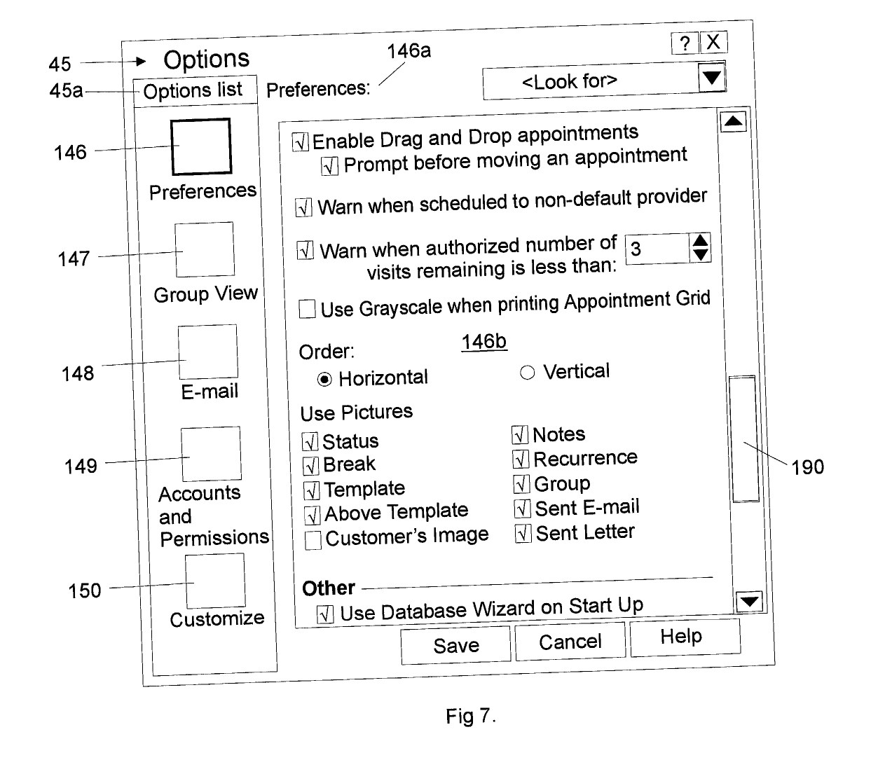

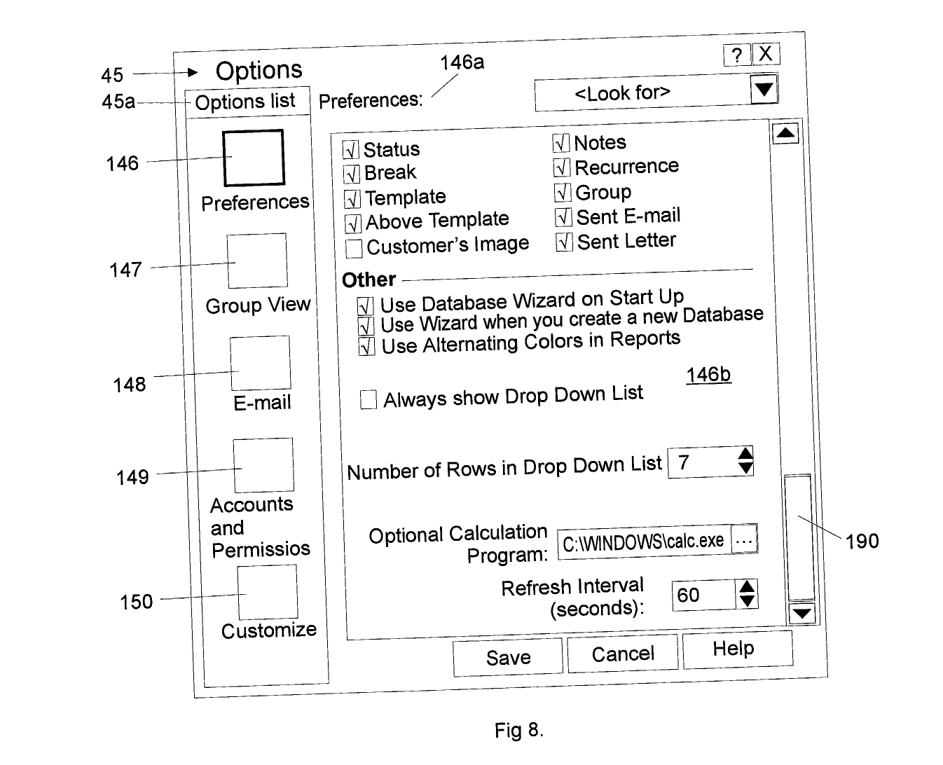

Options button 45 opens a separate Window—see FIG. 5 to which reference is now made. Options list 45a is comprised of five buttons, Preferences 146, Group View 147, E-Mail 148, Accounts and Permissions 149, Customize 150. Clicking on any of these buttons changes the view as shown in FIG. 5 as 146b. In FIG. 5, choices are now presented to the user to allow modification to provider/customer profiles and to the temporal features of the program and its appearance in terms of Font style and color. Text label 146a denotes the screen under review. FIGS. 6-8 illustrate the other option choices revealed as scroll bar 190 is slid downward.

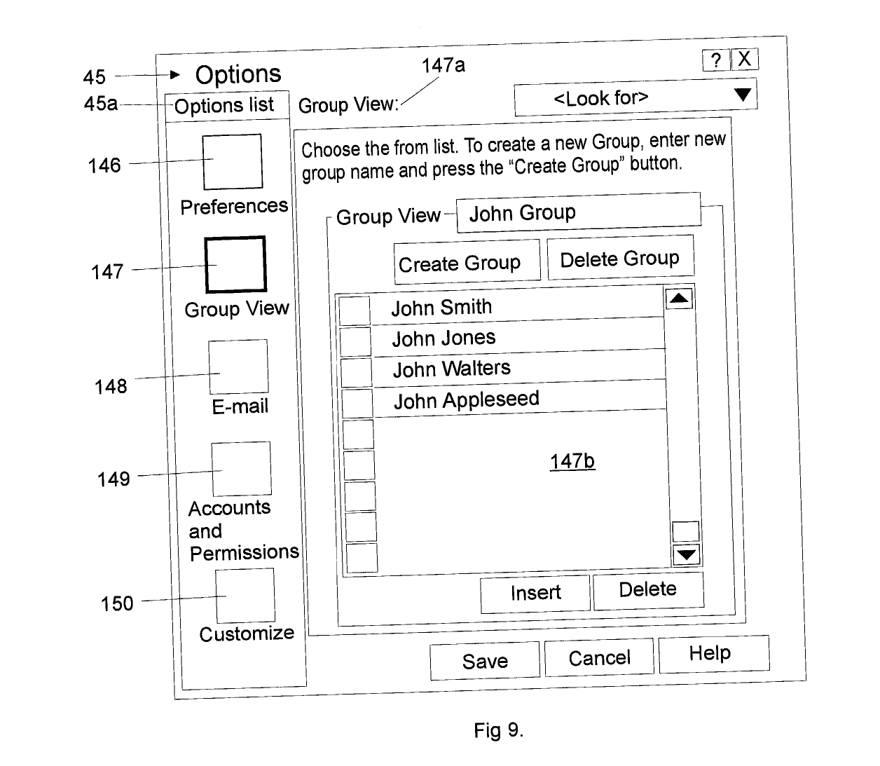

Referring now to FIG. 9 in which Group View button 147 is active. Screen area 147b contains a scroll list of items from which the user can choose in order to insert or delete items from the list.

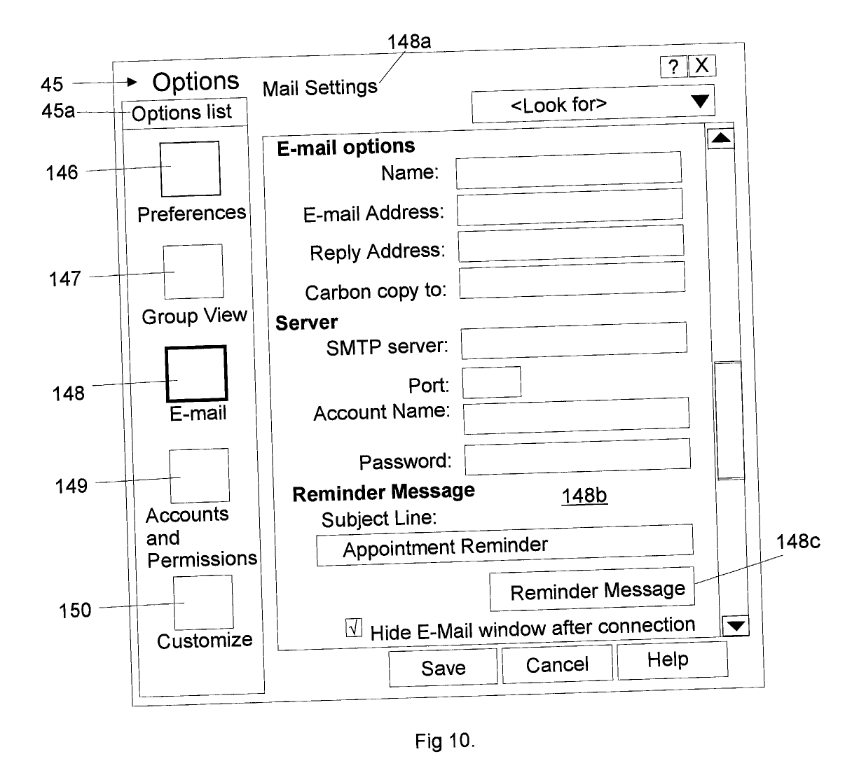

Referring now to FIG. 10 in which E-Mail button 148 is active. Screen area 148b now presents E-Mail address options and buttons to access a Reminder message 148c stored as a text file in the relevant database. In operation the E-Mail functions described are used to send E-mail to customers, patients etc to remind them of appointments or other scheduled events.

Referring again to FIG. 11, in which Accounts and Permissions button 149 is active, Screen Area 149b displays buttons to choose among users (Administrators, Guests, Users, Power Users) and other menu options including Security, Options, File, Data, and Reports, each of which, when clicked and expanded displays check boxes to activate/ deactivate features.

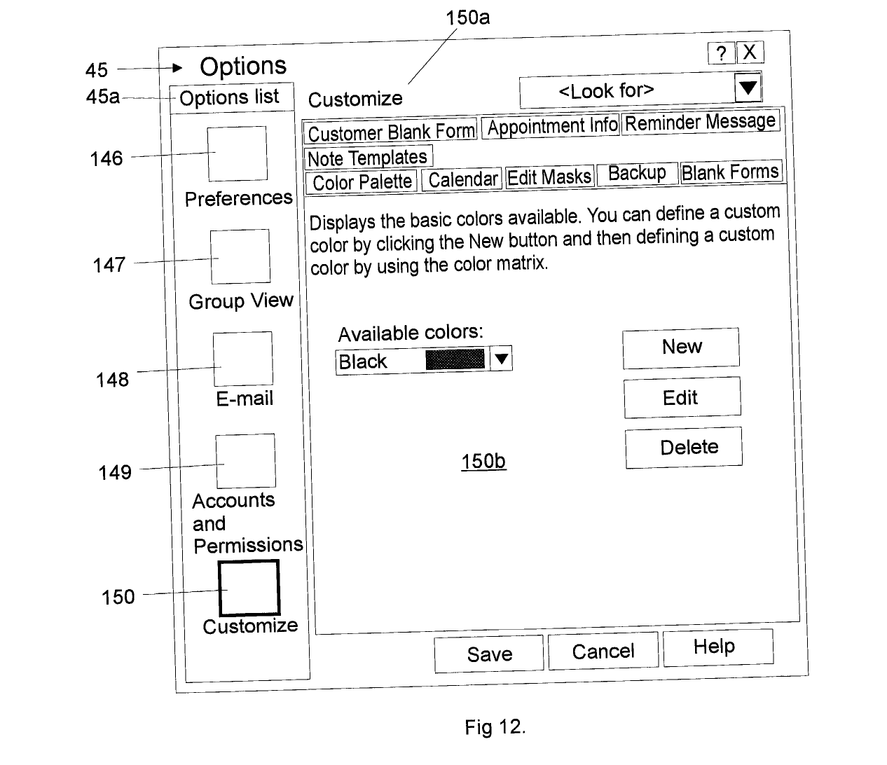

Referring now to FIG. 12 in which Customize button 150 is active, screen area 150b displays selectable components and features such as Customer Blank Form, Appointment info, Reminder Message, Note Templates, Color Palette, Calendar, Edit Masks, Backup and Blank Forms. Selecting any of these permits the user to view screens to modify and customize the look and feel of each of the listed components.

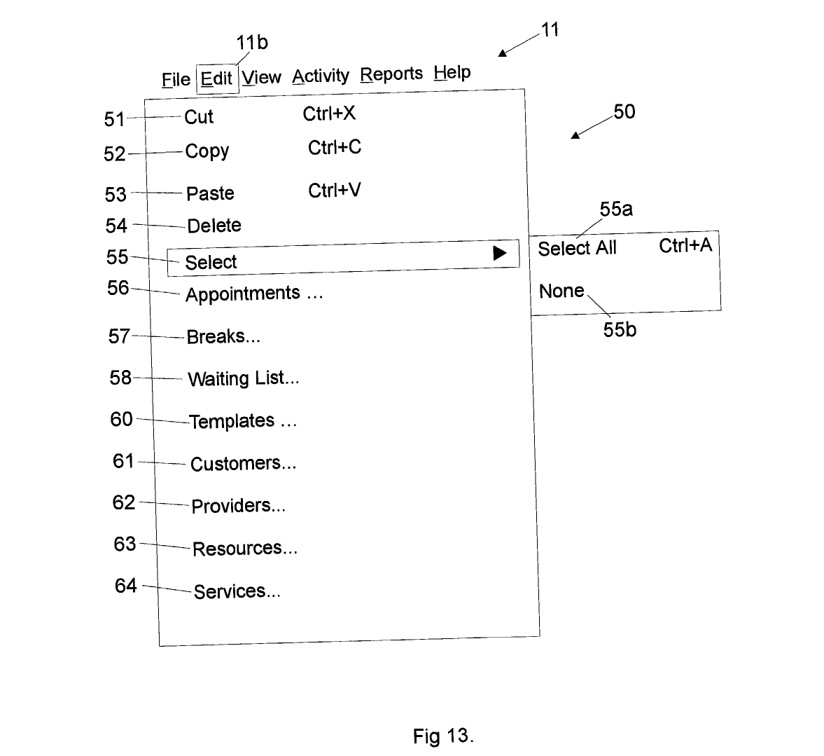

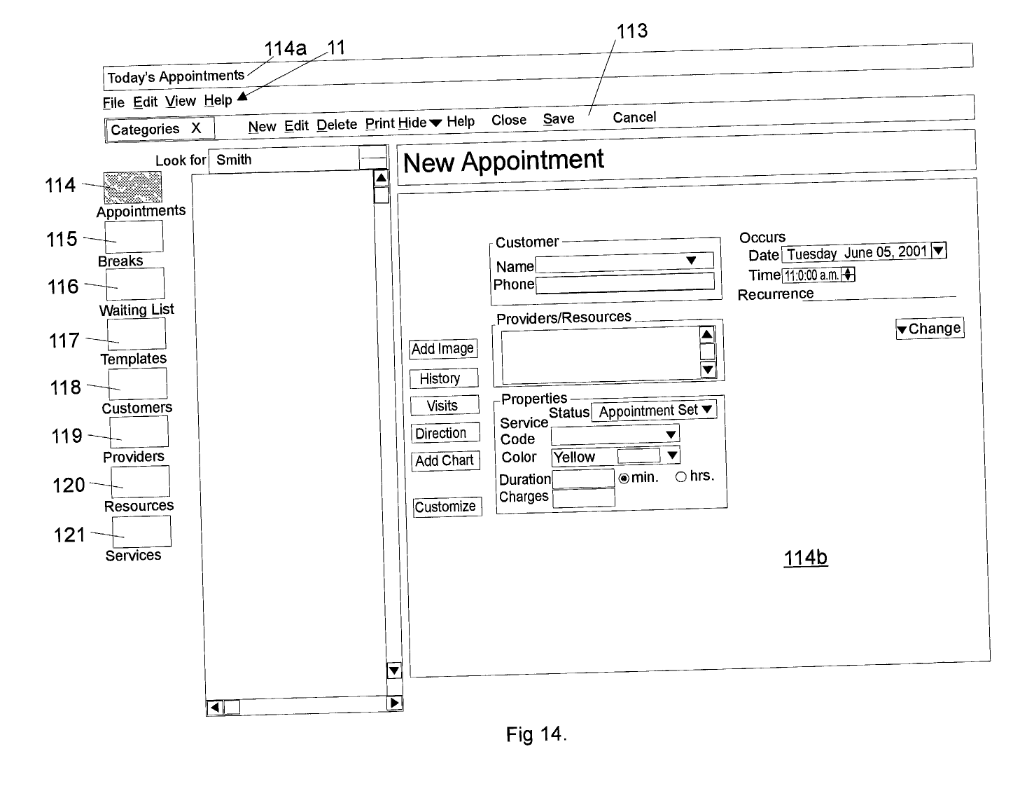

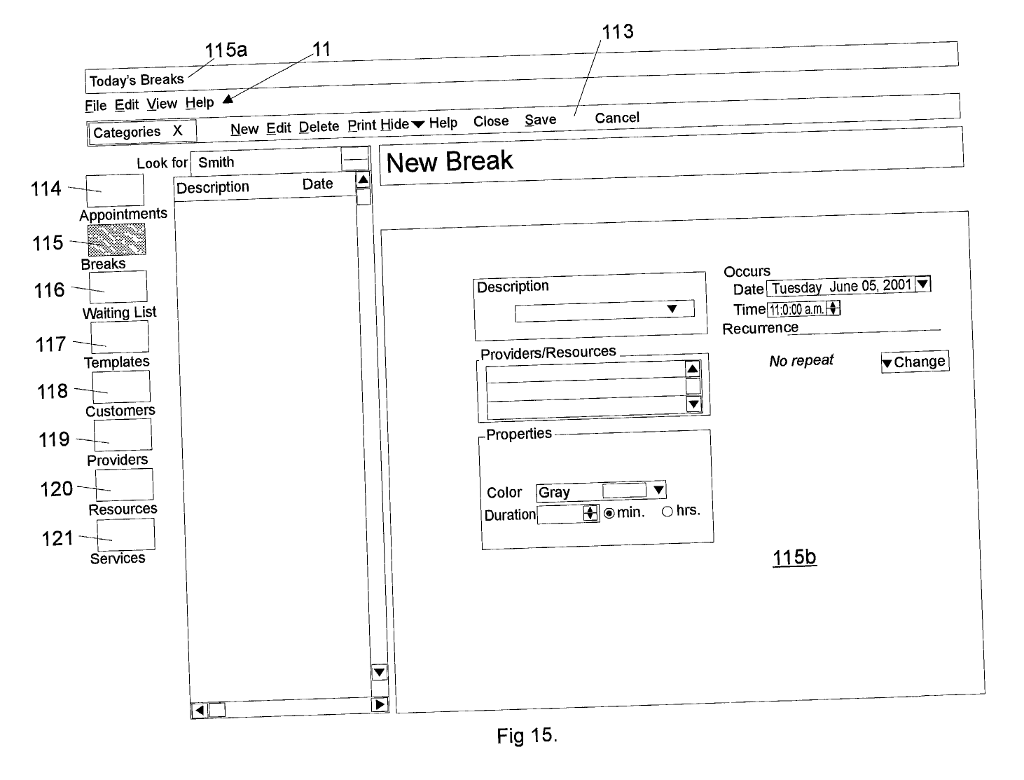

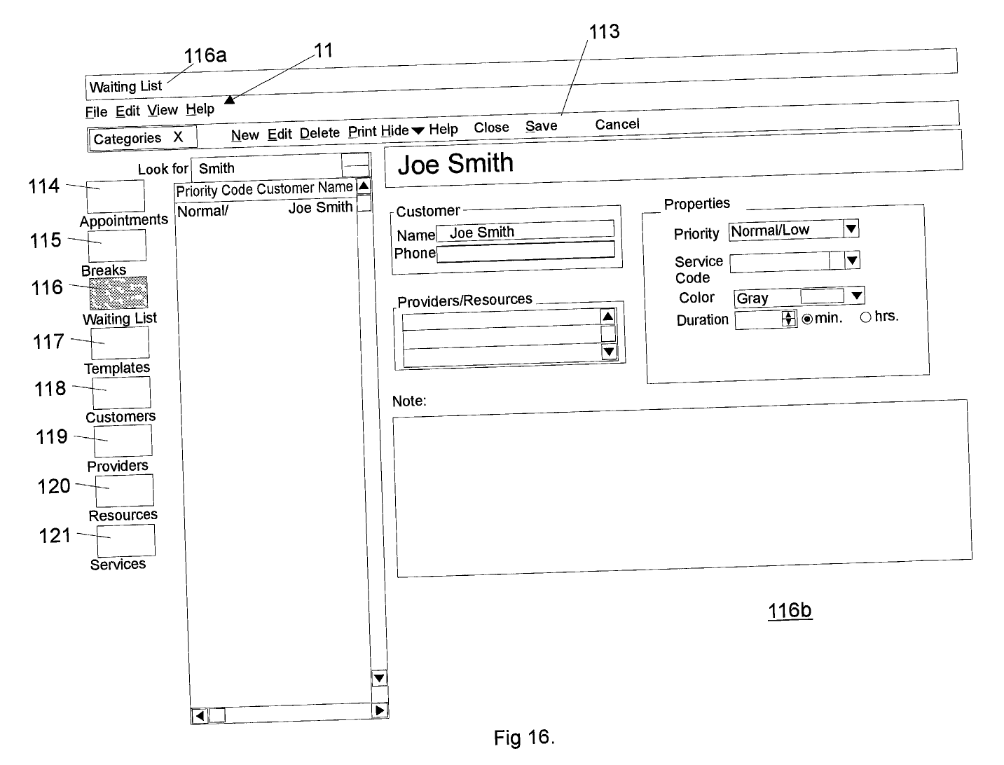

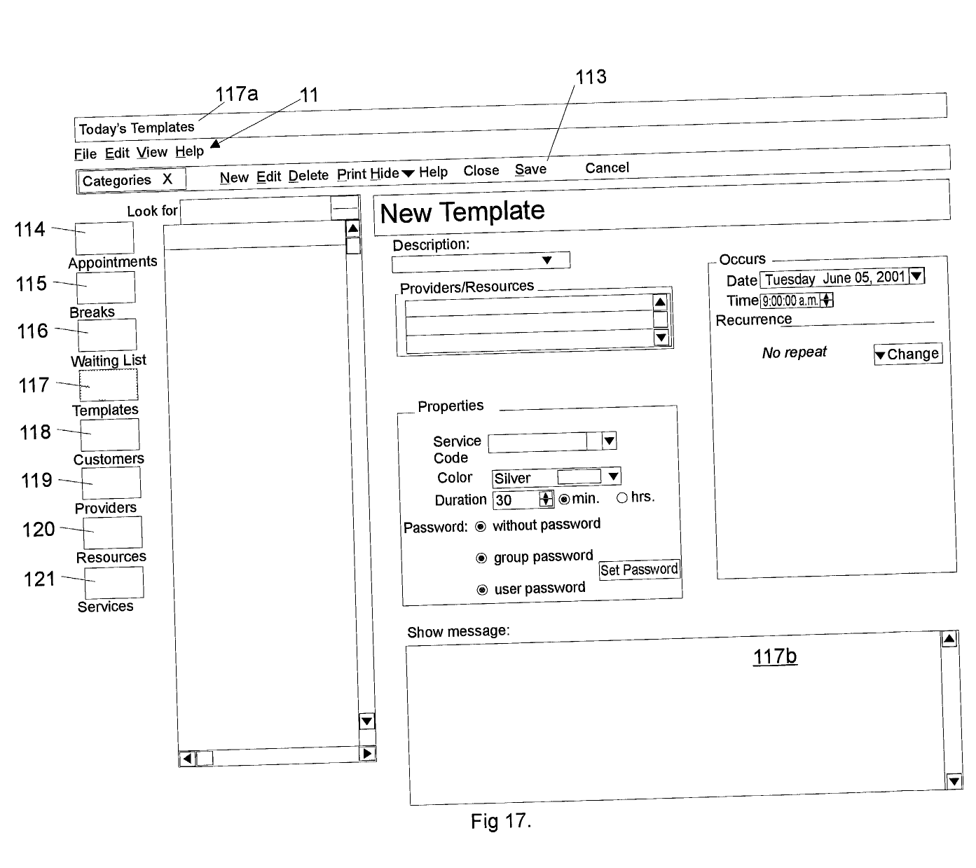

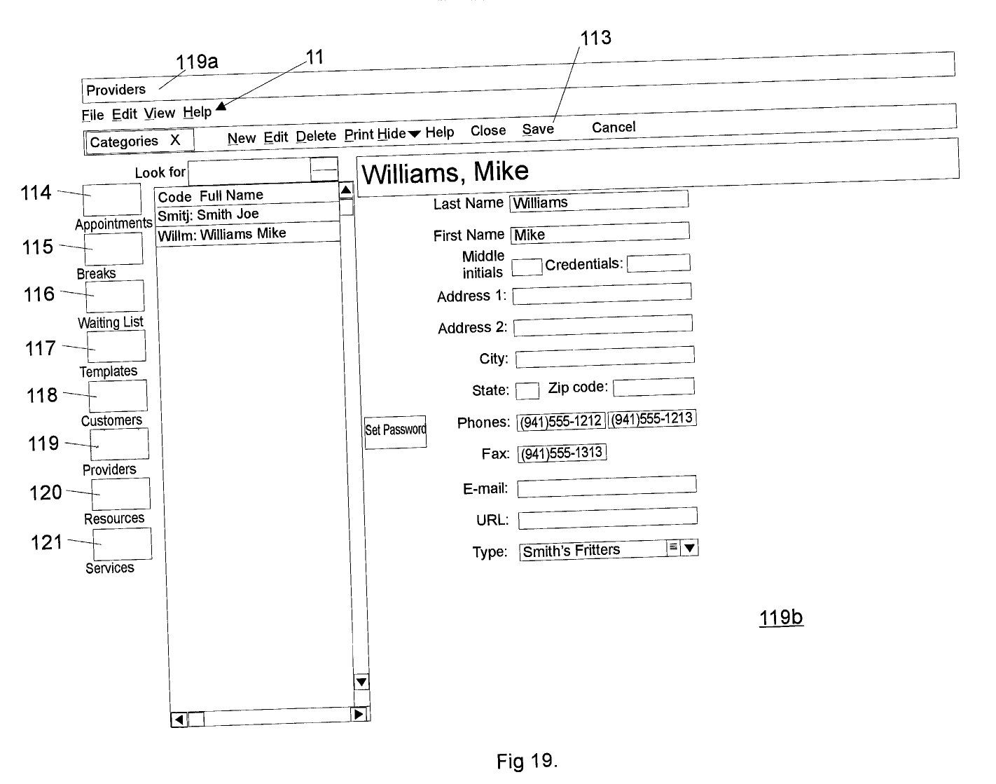

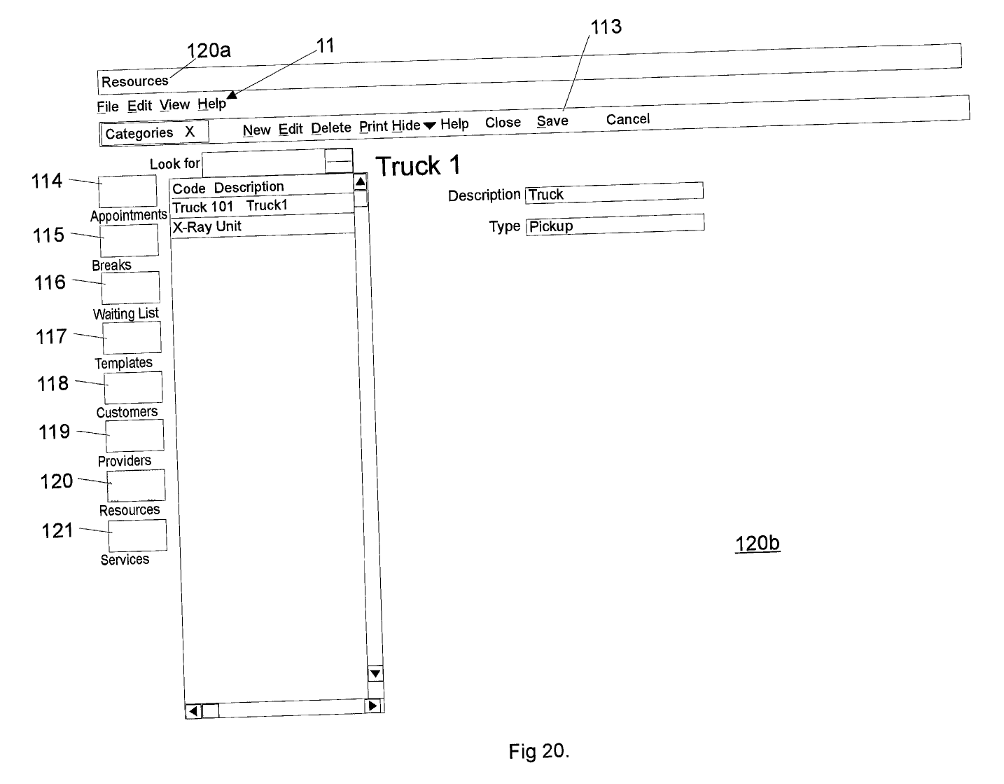

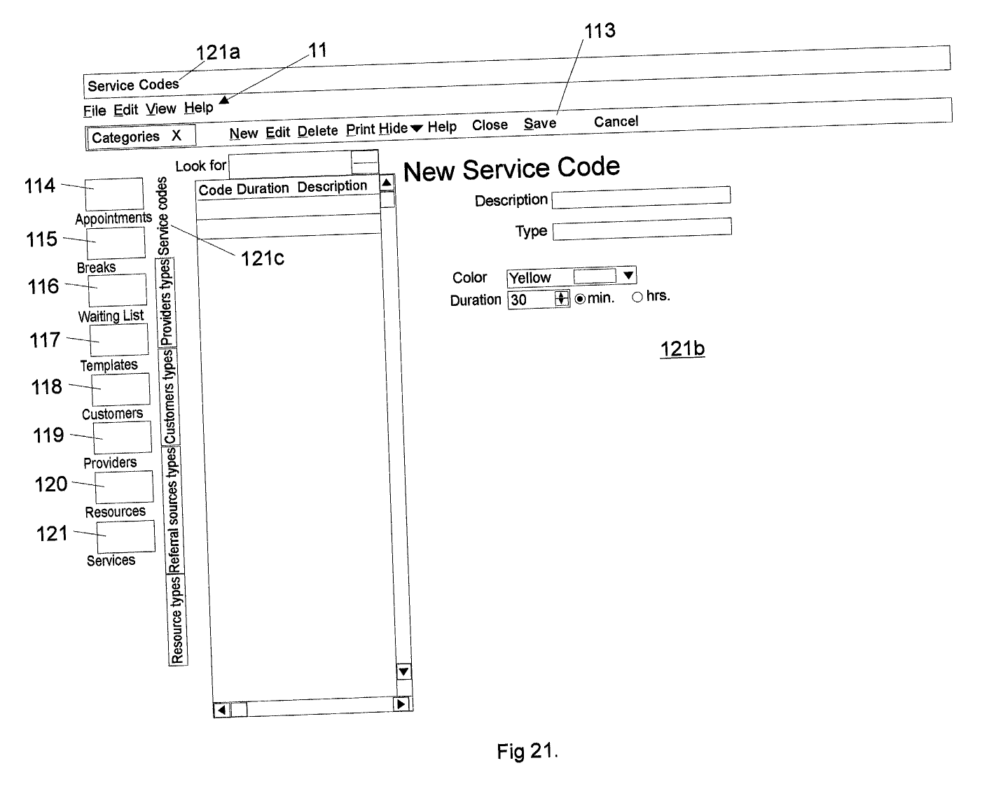

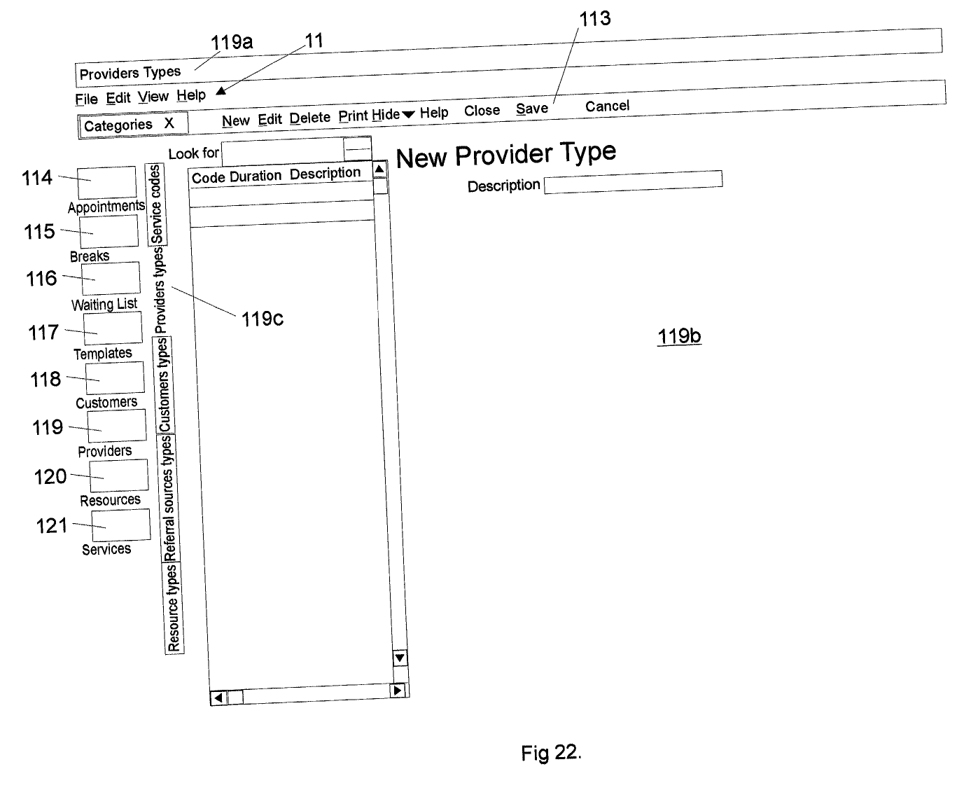

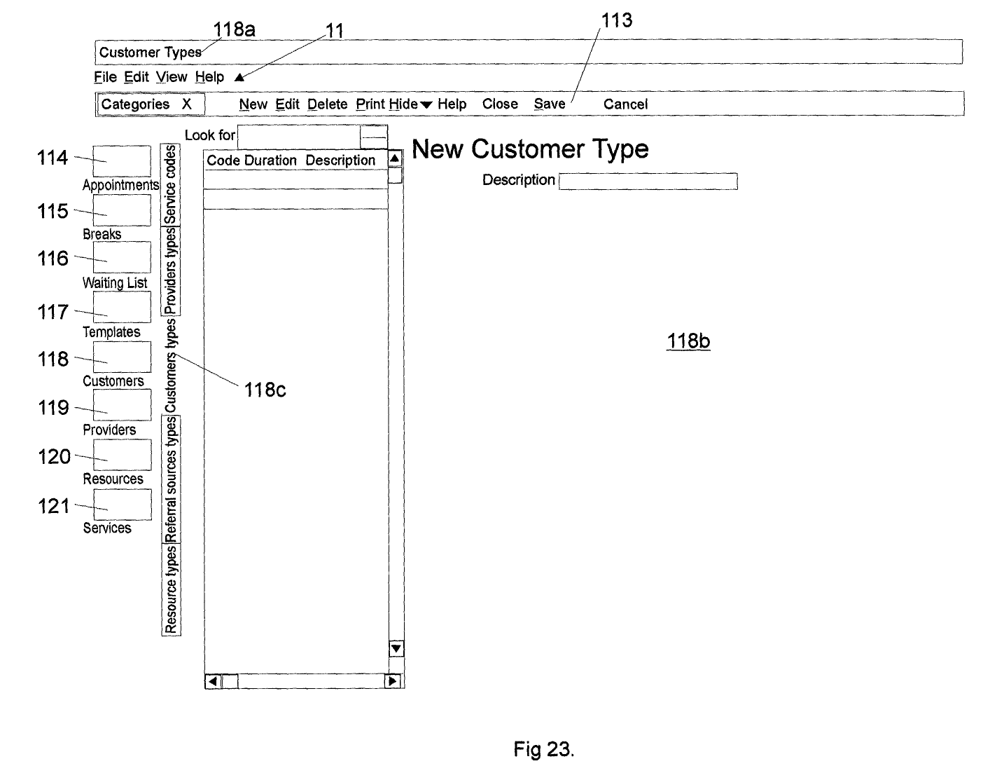

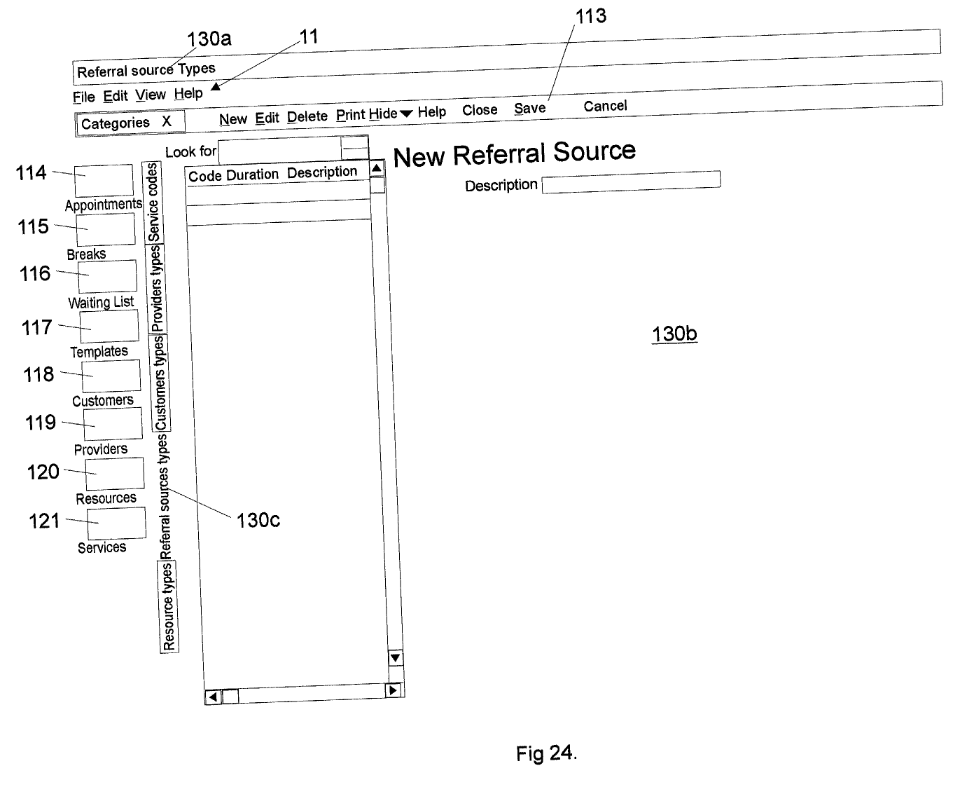

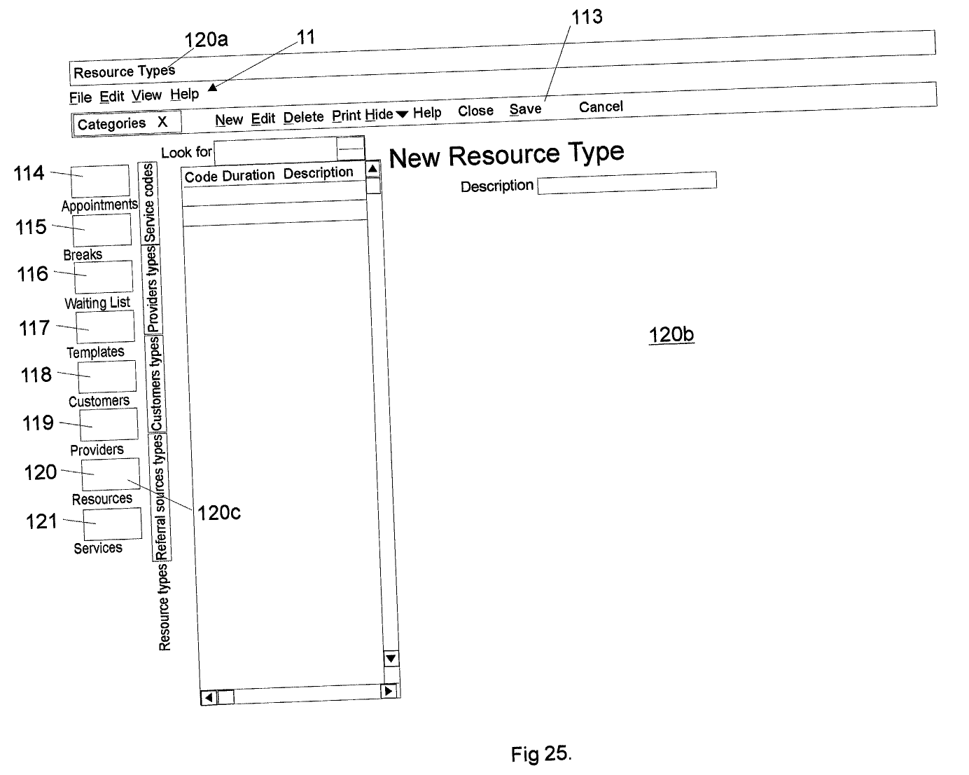

Referring now to FIG. 13 in which Edit menu 11b features are displayed. Buttons 51-64 are the choices the user has by which a feature can be accessed for editing. FIGS. 14-25 specify each of these screens and the options therein.

Referring now to FIG. 14 which shows buttons 114-121 arranged vertically on the screen left side. Button 114 is the active button (shown shaded) and displays appointment details for a New Appointment in screen area 114b. This layout format remains the same for each subsequent screen (FIGS. 14-25) wherein the active button presents options to the user by which the present invention calendar is modified. The act of entering new information, such as a New Appointment, automatically updates the relevant database which thereafter makes such data available for the extensive report features of the present invention.

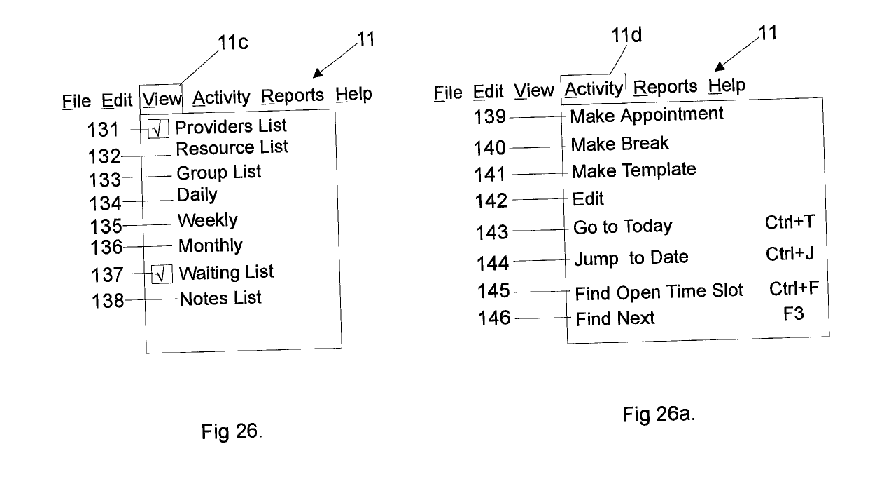

Referring now to FIGS. 26 and 26a which illustrate further features available on the View and Activity menus. On View menu 11c items 131-138 are the views which can be immediately displayed to the user. This is one of the key features of the present invention, the capability of quickly changing between key views by accessing the Menu Bar 11 from the main program screens. In FIG. 26a, items 139-146 are each action steps which are similarly accessible through the main screen Menu 11.

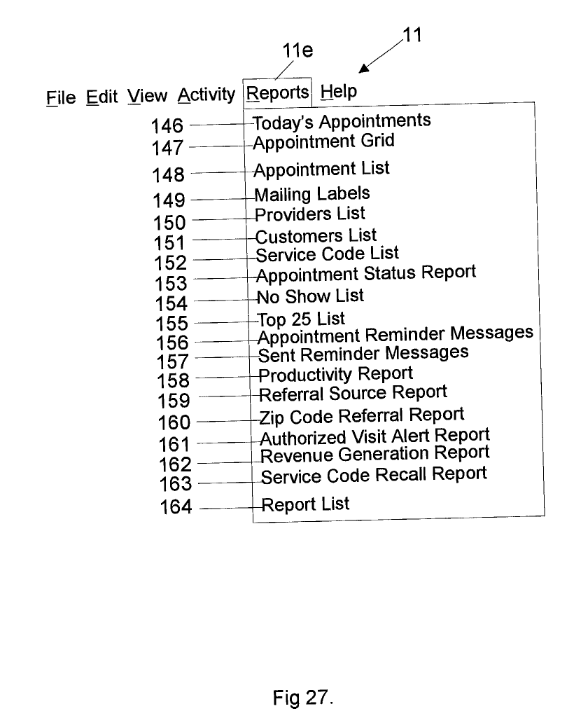

Referring now to FIG. 27 in which report menu item 11e gives access to a multiplicity of report type as designated by items 146-164. This is a further key feature of the present invention in that it provides to the user a management tool by which customer activities, preferences and other key information can be extracted from the relevant databases. Item 160 Zip Code Referral report for example generates a report enabling the user to determine which Zip codes produce the most/least referrals and by so doing is able to adjudicate the relative value of promotional campaigns in a given area.

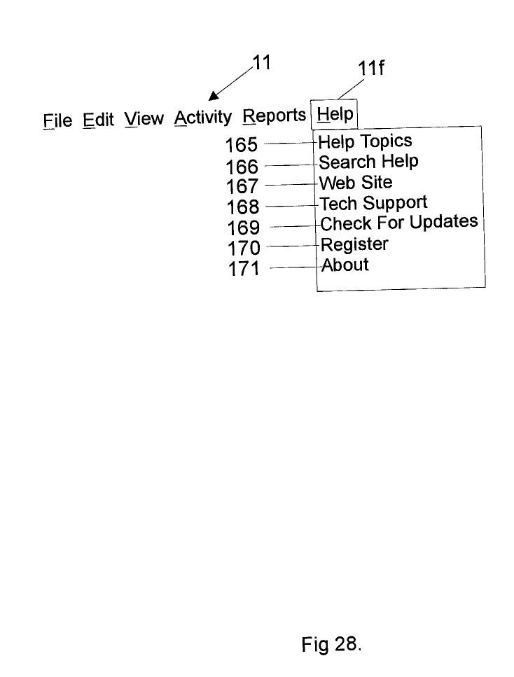

Referring now to FIG. 28 in which various logistical features are accessed. Items 165 and 166 are standard Microsoft Windows® type Help topics through which the user obtains Help from information contained within the present invention's database. Item 167 automatically connects the user to a Web Site containing further information concerning the program. Item 168 Tech Support connects the user to an Internet connected Technical Support facility. Items 169 similarly connects the user to a Web Site containing program updates. Item 170 connects the user to a Web Site wherein the usesr can register as an authorized user.

In operation the features described can be operated to perform a variety of functions according to the need of the user. Some examples include;

An Oil Lube/Change shop uses the present invention calendar program to schedule oil changes. Assuming that all customers should have their oil changed every three months but they put off changing their oil (lost revenue to user). By going to Reports (11e FIG. 27) and then to Service Code Recall report (163) and entering today's date, (and range of customer codes if desired), then entering the “service code” that is being searched, enter the time period for which the search is required (2w for 2 weeks; 2m for 2 months; 2y for 2 years, etc) in order to see who has not had that service code in that time frame. Once the report prints the user's employees can begin calling the customers to remind them its time to schedule another oil change.

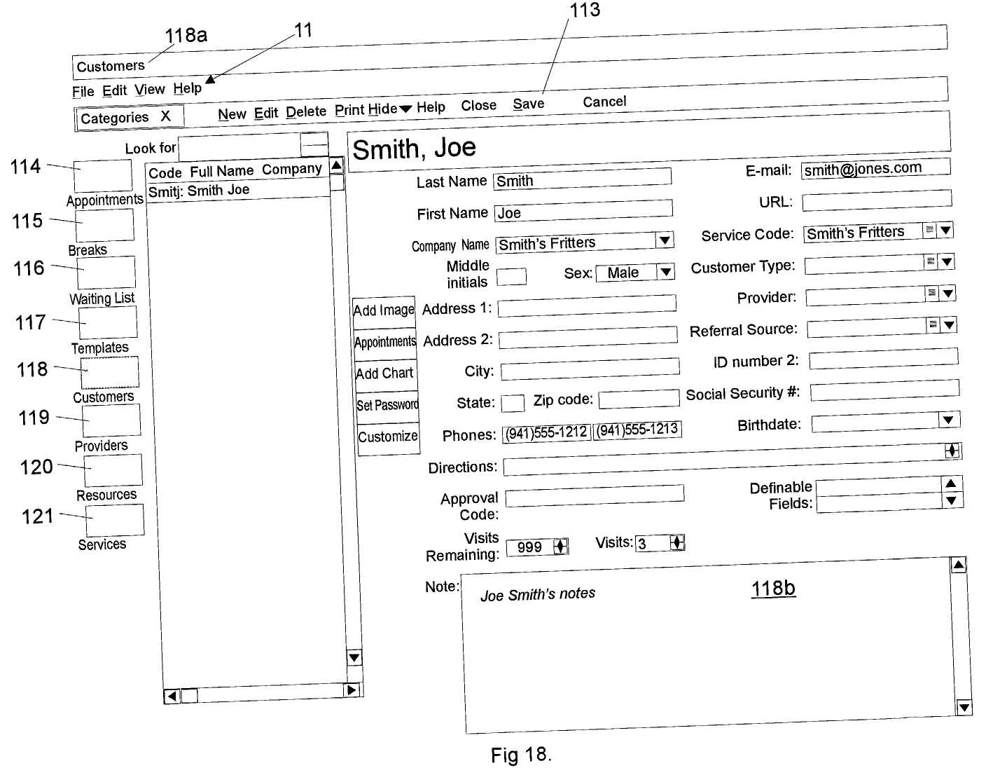

There are feature buttons in the “appointment entry/appointment edit” window, and the “customer edit” window, a button to link to a graphic picture for the customer, and the ability to create a master word processing document (or narrative note, or chart). There are buttons reading “add image” or “add chart” (FIG. 18). In use this feature could be used by a receptionist to recognize a customer upon arrival and to thereby personalize a greeting for the customer.

Based upon the description and features of the present invention, it will be understood by those skilled in the art, that the possible variations and combinations of features and database support available in the present invention demonstrate a unique and versatile calendar/scheduling program superior in scope and features to prior art disclosures and that various changes in form and detail may be made without departing from the spirit and scope of the invention.

What is claimed is:

1. A method for using a computer to facilitate the creation and maintenance of a database based scheduling calendar for the coordinated scheduling of discrete components in a professional, personal or service environment having a plurality of customizable display screens, comprising the steps of:
inputting into the computer updateable database information concerning persons designated as users, persons designated as providers, persons designated as customers and material, equipment, facilities designated as resources,
inputting into the computer a customizable programming means having a visual interface, said interface having a plurality of display screens, said display screens including a first screen, said screen having a plurality of textual boxes, said textual boxes individually being an interface means, said first screen having a central grid, said grid having a first vertical axis and a second horizontal axis, a first top portion, and a second bottom portion, a first left side and a second right side, a plurality of time slot rectangles formed at intersections of said vertical and said horizontal axes, said time slot rectangles individually being an interface means, said grid having a time scale, said time scale being positioned at said left or said right side of said grid, said grid having a day/date scale, said scale being aligned with said horizontal or said vertical axis of said grid and said scale being positioned at said top or said bottom of said grid, said time slot rectangles each individually corresponding on said grid axis to said time scale and on said grid axis to said day/date scale forming thereby the appearance of a first schedule grid;
accessing said database through said interfaces, thereby inputting into said database new information relating to said providers, customers, and resources;
accessing said database through said interfaces thereby outputting from said database specific information relating to said providers, customers and resources; and
accessing said database through said interfaces thereby adjusting the appearance and function of said scheduling calendar.

2. The method of claim 1, further comprising the steps of:
viewing said scheduling calendar from a daily view, a weekly view or a monthly view,
viewing lists of available providers, customers and resources,
organizing said providers, customers and resources into groups,
maintaining a visible waiting list of customers, moving said waiting list of said customers individually to open time slot rectangles by dragging and dropping,
adding or modifying textual or graphic attachments to said database information corresponding to individual customers, providers and resources and,
modifying display colors of said display screen to effect identifying color codes for said appointment, customers, providers, resources and users,
generating written reports from said database said reports denoting, current appointments, an appointment grid, an appointment list, mailing labels, providers list, customers list, service code list, appointment status report, no show list, top 25 list, appointment reminder messages, sent reminder messages, productivity report, referral source report, zip code referral report, authorized visit alert report, revenue generation report, service code recall report and a report list, presetting access levels and passwords among providers, customers and users said access levels being adjustable to permit limited access by said customers and said users to said scheduling calendar, said access being sufficient to inform said customer and said users of available time slots on said scheduling calendar, said access enabling said customer and said users to reserve said available time slots, notifying and reminding said customers of scheduled appointment by electronic or written means, and
an internet based updating means for permitting users to acquire a current version of said scheduling calendar, said update means being accessed through said interface.
